(19) United States
(12) Patent Application Publication
(10) Pub. No.: US 2012/0072035 A1
(43) Pub. Date: Mar. 22, 2012

(54) METHODS AND APPARATUS FOR DISPENSING MATERIAL AND ELECTRONICALLY TRACKING SAME

(76) Inventors: Steven Nielsen, North Palm Beach, FL (US); Curtis Chambers, Palm Beach Gardens, FL (US); Jeffrey Farr, Jupiter, FL (US)

(21) Appl. No.: 13/232,790

(22) Filed: Sep. 14, 2011

Related U.S. Application Data
(60) Provisional application No. 61/384,158, filed on Sep. 17, 2010.
(60) Provisional application No. 61/383,824, filed on Sep. 17, 2010.
(60) Provisional application No. 61/451,007, filed on Mar. 9, 2011.

(51) Int. Cl. G05D 7/06

(52) U.S. Cl. 700/283

(57) ABSTRACT

A dispensing device is provided for use in a dispensing operation. The dispensing device includes a hand-held housing, a memory to store processor-executable instructions, a processor coupled to the memory and disposed within or communicatively coupled to the hand-held housing, and a camera system mechanically and/or communicatively coupled to the dispensing device to provide image information to the processor. The image information relates to the dispensing operation. The dispensing device also includes a dispensing mechanism to control dispensing of the material. The material is not readily visible after the dispensing operation. The processor analyzes the image information to determine tracking information indicative of a motion or an orientation of the dispensing device. The processor also determines actuation information relating to operation of the dispensing mechanism and stores the actuation information and the tracking information to provide an electronic record of geographic locations at which the material is dispensed.

### CROSS-REFERENCE TO RELATED PATENT APPLICATIONS

This application claims a priority benefit, under 35 U.S.C. §119(e), to U.S. provisional patent application Ser. No. 61/383,824, filed on Sep. 17, 2010, entitled “Enhanced Mobile Dispensing Devices From Which Dispensed Material May not be Observable After Use.”

This application also claims a priority benefit, under 35 U.S.C. §119(e), to U.S. provisional patent application Ser. No. 61/384,158, filed on Sep. 17, 2010, entitled “Methods and Apparatus for Tracking Motion and/or Orientation of Marking Device.”

This application also claims a priority benefit, under 35 U.S.C. §119(e), to U.S. provisional patent application Ser. No. 61/451,007, filed Mar. 9, 2011, entitled “Methods and Apparatus for Tracking Motion and/or Orientation of Marking Device.”

Each of the foregoing provisional applications is hereby incorporated by reference herein in its entirety.

### BACKGROUND

Field service operations may be any operation in which companies dispatch technicians and/or other staff to perform certain activities, for example, installations, services and/or repairs. Field service operations may exist in various industries, examples of which include, but are not limited to, network installations, utility installations, security systems, construction, medical equipment, heating, ventilating and air conditioning (HVAC) and the like.

A particular class of field service operations relates to dispensing various materials (e.g., liquids, sprays, powders). Examples of such services include dispensing liquid pesticides in home and/or office environments, dispensing liquid weed killers and/or fertilizers for lawn treatments, dispensing liquid weed killers and/or fertilizers in large-scale grower environments (e.g., large-scale grower of plants for sale and/or crops), and the like.

### SUMMARY

The Inventors have recognized and appreciated that for field service operations particularly involving dispensed materials, in some instances the dispensed material may not be readily observable in the environment in which it is dispensed. Accordingly, it may be difficult to verify that in fact the material was dispensed, where the material was dispensed, and/or how much of the material was dispensed. More generally, the Inventors have recognized and appreciated that the state of the art in field service operations involving dispensed materials does not readily provide for verification and/or quality control processes particularly in connection with dispensed materials that may be difficult to observe once dispensed.

In view of the foregoing, various embodiments of the present invention relate generally to methods and apparatus for dispensing materials and tracking same. In various implementations described herein, inventive methods and apparatus are configured to facilitate dispensing of a material (e.g., via a hand-held apparatus operated by a field technician), verifying that in fact material was dispensed from a dispensing apparatus, and tracking the geographic location of the dispensing activity during field service operations.

In some embodiments, tracking of the geographic location of a dispensing activity is accomplished via processing of image information acquired during the field service operations so as to determine movement and/or orientation of a device/apparatus employed to dispense the material. Various information relating to the dispensing activity and, more particularly, the geographic location of dispensed material, may be stored electronically to provide an electronic record of the dispensing activity. Such an electronic record may be used as verification for the dispensing activity, and or further reviewed/processed for quality assessment purposes in connection with the field service/dispensing activity.

In exemplary implementations, enhanced mobile dispensing devices according to various embodiments of the present invention may be geo-enabled electronic dispensing devices from which electronic information may be collected about the dispensing operations performed therewith. In this way, electronic records may be created about the dispensing operations in which the dispensed material may not be visible and/or otherwise observable. The enhanced mobile dispensing devices according to various embodiments may be implemented in a variety of form factors, example of which include, but are not limited to, an enhanced spray wand, an enhanced spray gun, an enhanced spray applicator, and the like for use with, for example, hand sprayers, backpack sprayers, truck-based bulk sprayers, and the like.

In sum, one embodiment of the invention is directed to a dispensing device for use in performing a dispensing operation to dispense a material. The dispensing device includes a hand-held housing, a memory to store processor-executable instructions, and at least one processor coupled to the memory and disposed within or communicatively coupled to the hand-held housing. The dispensing device also includes at least one camera system mechanically and/or communicatively coupled to the dispensing device so as to provide image information to the at least one processor. The image information relates to the dispensing operation. The dispensing device also includes a dispensing mechanism to control dispensing of the material. The material is not readily visible after the dispensing operation. Upon execution of the processor-executable instructions, the at least one processor analyzes the image information to determine tracking information indicative of a motion or an orientation of the dispensing device. The at least one processor also determines actuation information relating at least in part to user operation of the dispensing mechanism. The at least one processor also stores the actuation information and the tracking information in the memory so as to provide an electronic record of one or more geographic locations at which the material is dispensed by the dispensing device.

Another embodiment of the invention is directed to a computer program product. The computer program product includes a non-transitory computer readable medium having a computer readable program code embodied therein. The computer readable program code is adapted to be executed to implement a method. The method includes receiving image information from at least one camera system. The camera system is mechanically and/or communicatively coupled to a dispensing device. The dispensing device is adapted to dispense a material. The dispensing device has a dispensing mechanism to control dispensing of the material. The material is not readily visible after the dispensing operation. The method also includes analyzing the image information to determine tracking information indicative of a motion or an orientation of the dispensing device. The method also includes determining actuation information relating at least in part to user operation of the dispensing mechanism. The method also includes storing the actuation information and the tracking information in a memory so as to provide an electronic record of one or more geographic locations at which the material is dispensed by the dispensing device.

Another embodiment of the invention is directed to a method of performing a dispensing operation to dispense a material. The method includes receiving image information from at least one camera system. The camera system is mechanically and/or communicatively coupled to a dispensing device. The dispensing device is adapted to dispense a material. The dispensing device has a dispensing mechanism to control dispensing of the material. The material is not readily visible after the dispensing operation. The method also includes analyzing the image information to determine tracking information indicative of a motion or an orientation of the dispensing device. The method also includes determining actuation information relating at least in part to user operation of the dispensing mechanism. The method also includes storing the actuation information and the tracking information in a memory so as to provide an electronic record of one or more geographic locations at which the material is dispensed by the dispensing device.

The following U.S. published patents and applications are hereby incorporated herein by reference in their entirety:

U.S. patent application Ser. No. 13/210,291, filed Aug. 15, 2011, and entitled “Methods, Apparatus and Systems for Surface Type Detection in Connection with Locate and Marking Operations;”

U.S. patent application Ser. No. 13/210,237, filed Aug. 15, 2011, and entitled “Methods, Apparatus and Systems for Marking Material Color Detection in Connection with Locate and Marking Operations;”

U.S. Pat. No. 7,640,105, issued Dec. 29, 2009, filed Mar. 13, 2007, and entitled “Marking System and Method With Location and/or Time Tracking;”

U.S. publication no. 2010-0094553-A1, published Apr. 15, 2010, filed Dec. 16, 2009, and entitled “Systems and Methods for Using Location Data and/or Time Data to Electronically Display Dispensing of Markers by A Marking System or Marking Tool;”

U.S. publication no. 2008-0245299-A1, published Oct. 9, 2008, filed Apr. 4, 2007, and entitled “Marking System and Method;”

U.S. publication no. 2009-0013928-A1, published Jan. 15, 2009, filed Sep. 24, 2008, and entitled “Marking System and Method;”

U.S. publication no. 2010-0090858-A1, published Apr. 15, 2010, filed Dec. 16, 2009, and entitled “Systems and Methods for Using Marking Information to Electronically Display Dispensing of Markers by a Marking System or Marking Tool;”

U.S. publication no. 2009-0238414-A1, published Sep. 24, 2009, filed Mar. 18, 2008, and entitled “Virtual White Lines for Delimiting Planned Excavation Sites;”

U.S. publication no. 2009-0241045-A1, published Sep. 24, 2009, filed Sep. 26, 2008, and entitled “Virtual White Lines for Delimiting Planned Excavation Sites;”

U.S. publication no. 2009-0238415-A1, published Sep. 24, 2009, filed Sep. 26, 2008, and entitled “Virtual White Lines for Delimiting Planned Excavation Sites;”

U.S. publication no. 2009-0241046-A1, published Sep. 24, 2009, filed Jan. 16, 2009, and entitled “Virtual White Lines for Delimiting Planned Excavation Sites;”

U.S. publication no. 2009-0238416-A1, published Sep. 24, 2009, filed Jan. 16, 2009, and entitled “Virtual White Lines for Delimiting Planned Excavation Sites;”

U.S. publication no. 2009-0237408-A1, published Sep. 24, 2009, filed Jan. 16, 2009, and entitled “Virtual White Lines for Delimiting Planned Excavation Sites;”

U.S. publication no. 2011-0135163-A1, published Jun. 9, 2011, filed Feb. 16, 2011, and entitled “Methods and Apparatus for Providing Unbuffered Dig Area Indicators on Aerial Images to Delimit Planned Excavation Sites;”

U.S. publication no. 2009-0202101-A1, published Aug. 13, 2009, filed Feb. 12, 2008, and entitled “Electronic Manifest of Underground Facility Locate Marks;”

U.S. publication no. 2009-0202110-A1, published Aug. 13, 2009, filed Sep. 11, 2008, and entitled “Electronic Manifest of Underground Facility Locate Marks;”

U.S. publication no. 2009-0201311-A1, published Aug. 13, 2009, filed Jan. 30, 2009, and entitled “Electronic Manifest of Underground Facility Locate Marks;”

U.S. publication no. 2009-0202111-A1, published Aug. 13, 2009, filed Jan. 30, 2009, and entitled “Electronic Manifest of Underground Facility Locate Marks;”

U.S. publication no. 2009-0204625-A1, published Aug. 13, 2009, filed Feb. 5, 2009, and entitled “Electronic Manifest of Underground Facility Locate Operation;”

U.S. publication no. 2009-0204466-A1, published Aug. 13, 2009, filed Sep. 4, 2008, and entitled “Ticket Approval System For and Method of Performing Quality Control In Field Service Applications;”

U.S. publication no. 2009-0207019-A1, published Aug. 20, 2009, filed Apr. 30, 2009, and entitled “Ticket Approval System For and Method of Performing Quality Control In Field Service Applications;”

U.S. publication no. 2009-0210284-A1, published Aug. 20, 2009, filed Apr. 30, 2009, and entitled “Ticket Approval System For and Method of Performing Quality Control In Field Service Applications;”

U.S. publication no. 2009-0210297-A1, published Aug. 20, 2009, filed Apr. 30, 2009, and entitled “Ticket Approval System For and Method of Performing Quality Control In Field Service Applications;”

U.S. publication no. 2009-0210298-A1, published Aug. 20, 2009, filed Apr. 30, 2009, and entitled “Ticket Approval System For and Method of Performing Quality Control In Field Service Applications;”

U.S. publication no. 2009-0210285-A1, published Aug. 20, 2009, filed Apr. 30, 2009, and entitled “Ticket Approval System For and Method of Performing Quality Control In Field Service Applications;”

U.S. publication no. 2009-0324815-A1, published Dec. 31, 2009, filed Apr. 24, 2009, and entitled “Marking Apparatus and Marking Methods Using Marking Dispenser with Machine-Readable ID Mechanism;”

U.S. publication no. 2010-0006667-A1, published Jan. 14, 2010, filed Apr. 24, 2009, and entitled, “Marker Detection Mechanisms for use in Marking Devices And Methods of Using Same;”

U.S. publication no. 2010-0085694 A1, published Apr. 8, 2010, filed Sep. 30, 2009, and entitled, “Marking Device Docking Stations and Methods of Using Same;”

U.S. publication no. 2010-0085701 A1, published Apr. 8, 2010, filed Sep. 30, 2009, and entitled, “Marking Device Docking Stations Having Security Features and Methods of Using Same;”

U.S. publication no. 2010-0084532 A1, published Apr. 8, 2010, filed Sep. 30, 2009, and entitled, “Marking Device Docking Stations Having Mechanical Docking and Methods of Using Same;”

U.S. publication no. 2010-0088032-A1, published Apr. 8, 2010, filed Sep. 29, 2009, and entitled, “Methods, Apparatus and Systems for Generating Electronic Records of Locate And Marking Operations, and Combined Locate and Marking Apparatus for Same;”

U.S. publication no. 2010-0117654 A1, published May 13, 2010, filed Dec. 30, 2009, and entitled, “Methods and Apparatus for Displaying an Electronic Rendering of a Locate and/or Marking Operation Using Display Layers;”

U.S. publication no. 2010-0086677 A1, published Apr. 8, 2010, filed Aug. 11, 2009, and entitled, “Methods and Apparatus for Generating an Electronic Record of a Marking Operation Including Service-Related Information and Ticket Information;”

U.S. publication no. 2010-0086671 A1, published Apr. 8, 2010, filed Nov. 20, 2009, and entitled, “Methods and Apparatus for Generating an Electronic Record of A Marking Operation Including Service-Related Information and Ticket Information;”

U.S. publication no. 2010-0085376 A1, published Apr. 8, 2010, filed Oct. 28, 2009, and entitled, “Methods and Apparatus for Displaying an Electronic Rendering of a Marking Operation Based on an Electronic Record of Marking Information;”

U.S. publication no. 2010-0088164-A1, published Apr. 8, 2010, filed Sep. 30, 2009, and entitled, “Methods and Apparatus for Analyzing Locate and Marking Operations with Respect to Facilities Maps;”

U.S. publication no. 2010-0088134 A1, published Apr. 8, 2010, filed Oct. 1, 2009, and entitled, “Methods and Apparatus for Analyzing Locate and Marking Operations with Respect to Historical Information;”

U.S. publication no. 2010-0088031 A1, published Apr. 8, 2010, filed Sep. 28, 2009, and entitled, “Methods and Apparatus for Generating an Electronic Record of Environmental Landmarks Based on Marking Device Actuations;”

U.S. publication no. 2010-0188407 A1, published Jul. 29, 2010, filed Feb. 5, 2010, and entitled “Methods and Apparatus for Displaying and Processing Facilities Map Information and/or Other Image Information on a Marking Device;”

U.S. publication no. 2010-0198663 A1, published Aug. 5, 2010, filed Feb. 5, 2010, and entitled “Methods and Apparatus for Overlaying Electronic Marking Information on Facilities Map Information and/or Other Image Information Displayed on a Marking Device;”

U.S. publication no. 2010-0188215 A1, published Jul. 29, 2010, filed Feb. 5, 2010, and entitled “Methods and Apparatus for Generating Alerts on a Marking Device, Based on Comparing Electronic Marking Information to Facilities Map Information and/or Other Image Information;”

U.S. publication no. 2010-0188088 A1, published Jul. 29, 2010, filed Feb. 5, 2010, and entitled “Methods and Apparatus for Displaying and Processing Facilities Map Information and/or Other Image Information on a Locate Device;”

U.S. publication no. 2010-0189312 A1, published Jul. 29, 2010, filed Feb. 5, 2010, and entitled “Methods and Apparatus for Overlaying Electronic Locate Information on Facilities Map Information and/or Other Image Information Displayed on a Locate Device;”

U.S. publication no. 2010-0188216 A1, published Jul. 29, 2010, filed Feb. 5, 2010, and entitled “Methods and Apparatus for Generating Alerts on a Locate Device, Based ON Comparing Electronic Locate Information TO Facilities Map Information and/or Other Image Information;”

U.S. publication no. 2010-0189887 A1, published Jul. 29, 2010, filed Feb. 11, 2010, and entitled “Marking Apparatus Having Enhanced Features for Underground Facility Marking Operations, and Associated Methods and Systems;”

U.S. publication no. 2010-0256825-A1, published Oct. 7, 2010, filed Jun. 9, 2010, and entitled “Marking Apparatus Having Operational Sensors For Underground Facility Marking Operations, And Associated Methods And Systems;”

U.S. publication no. 2010-0255182-A1, published Oct. 7, 2010, filed Jun. 9, 2010, and entitled “Marking Apparatus Having Operational Sensors For Underground Facility Marking Operations, And Associated Methods And Systems;”

U.S. publication no. 2010-0245086-A1, published Sep. 30, 2010, filed Jun. 9, 2010, and entitled “Marking Apparatus Configured To Detect Out-Of-Tolerance Conditions In Connection With Underground Facility Marking Operations, And Associated Methods And Systems;”

U.S. publication no. 2010-0247754-A1, published Sep. 30, 2010, filed Jun. 9, 2010, and entitled “Methods and Apparatus For Dispensing Marking Material In Connection With Underground Facility Marking Operations Based on Environmental Information and/or Operational Information;”

U.S. publication no. 2010-0262470-A1, published Oct. 14, 2010, filed Jun. 9, 2010, and entitled “Methods, Apparatus, and Systems For Analyzing Use of a Marking Device By a Technician To Perform An Underground Facility Marking Operation;”

U.S. publication no. 2010-0263591-A1, published Oct. 21, 2010, filed Jun. 9, 2010, and entitled “Marking Apparatus Having Environmental Sensors and Operations Sensors for Underground Facility Marking Operations, and Associated Methods and Systems;”

U.S. publication no. 2010-0188245 A1, published Jul. 29, 2010, filed Feb. 11, 2010, and entitled “Locate Apparatus Having Enhanced Features for Underground Facility Locate Operations, and Associated Methods and Systems;”

U.S. publication no. 2010-0253511-A1, published Oct. 7, 2010, filed Jun. 18, 2010, and entitled “Locate Apparatus Configured to Detect Out-of-Tolerance Conditions in Connection with Underground Facility Locate Operations, and Associated Methods and Systems;”

U.S. publication no. 2010-0257029-A1, published Oct. 7, 2010, filed Jun. 18, 2010, and entitled “Methods, Apparatus, and Systems For Analyzing Use of a Locate Device By a Technician to Perform an Underground Facility Locate Operation;”

U.S. publication no. 2010-0253513-A1, published Oct. 7, 2010, filed Jun. 18, 2010, and entitled “Locate Transmitter Having Enhanced Features For Underground Facility Locate Operations, and Associated Methods and Systems;”

U.S. publication no. 2010-0253514-A1, published Oct. 7, 2010, filed Jun. 18, 2010, and entitled “Locate Transmitter Configured to Detect Out-of-Tolerance Conditions In Connection With Underground Facility Locate Operations, and Associated Methods and Systems;”

U.S. publication no. 2010-0256912-A1, published Oct. 7, 2010, filed Jun. 18, 2010, and entitled “Locate Apparatus for Receiving Environmental Information Regarding Underground Facility Marking Operations, and Associated Methods and Systems;”

U.S. publication no. 2009-0204238-A1, published Aug. 13, 2009, filed Feb. 2, 2009, and entitled “Electronically Controlled Marking Apparatus and Methods;”

U.S. publication no. 2009-0208642-A1, published Aug. 20, 2009, filed Feb. 2, 2009, and entitled “Marking Apparatus and Methods For Creating an Electronic Record of Marking Operations;”

U.S. publication no. 2009-0210098-A1, published Aug. 20, 2009, filed Feb. 2, 2009, and entitled “Marking Apparatus and Methods For Creating an Electronic Record of Marking Apparatus Operations;”

U.S. publication no. 2009-0201178-A1, published Aug. 13, 2009, filed Feb. 2, 2009, and entitled “Methods For Evaluating Operation of Marking Apparatus;”

U.S. publication no. 2009-0238417-A1, published Sep. 24, 2009, filed Feb. 6, 2009, and entitled “Virtual White Lines for Indicating Planned Excavation Sites on Electronic Images;”

U.S. publication no. 2010-0205264-A1, published Aug. 12, 2010, filed Feb. 10, 2010, and entitled “Methods, Apparatus, and Systems for Exchanging Information Between Excavators and Other Entities Associated with Underground Facility Locate and Marking Operations;”

U.S. publication no. 2010-0205031-A1, published Aug. 12, 2010, filed Feb. 10, 2010, and entitled “Methods, Apparatus, and Systems for Exchanging Information Between Excavators and Other Entities Associated with Underground Facility Locate and Marking Operations;”

U.S. publication no. 2010-0259381-A1, published Oct. 14, 2010, filed Jun. 28, 2010, and entitled “Methods, Apparatus and Systems for Notifying Excavators and Other Entities of the Status of in-Progress Underground Facility Locate and Marking Operations;”

U.S. publication no. 2010-0262670-A1, published Oct. 14, 2010, filed Jun. 28, 2010, and entitled “Methods, Apparatus and Systems for Communicating Information Relating to the Performance of Underground Facility Locate and Marking Operations to Excavators and Other Entities;”

U.S. publication no. 2010-0259414-A1, published Oct. 14, 2010, filed Jun. 28, 2010, and entitled “Methods, Apparatus And Systems For Submitting Virtual White Line Drawings And Managing Notifications In Connection With Underground Facility Locate And Marking Operations;”

U.S. publication no. 2010-0268786-A1, published Oct. 21, 2010, filed Jun. 28, 2010, and entitled “Methods, Apparatus and Systems for Requesting Underground Facility Locate and Marking Operations and Managing Associated Notifications;”

U.S. publication no. 2010-0201706-A1, published Aug. 12, 2010, filed Jun. 1, 2009, and entitled “Virtual White Lines (VWL) for Delimiting Planned Excavation Sites of Staged Excavation Projects;”

U.S. publication no. 2010-0205555-A1, published Aug. 12, 2010, filed Jun. 1, 2009, and entitled “Virtual White Lines (VWL) for Delimiting Planned Excavation Sites of Staged Excavation Projects;”

U.S. publication no. 2010-0205195-A1, published Aug. 12, 2010, filed Jun. 1, 2009, and entitled “Methods and Apparatus for Associating a Virtual White Line (VWL) Image with Corresponding Ticket Information for an Excavation Project;”

U.S. publication no. 2010-0205536-A1, published Aug. 12, 2010, filed Jun. 1, 2009, and entitled “Methods and Apparatus for Controlling Access to a Virtual White Line (VWL) Image for an Excavation Project;”

U.S. publication no. 2010-0228588-A1, published Sep. 9, 2010, filed Feb. 11, 2010, and entitled “Management System, and Associated Methods and Apparatus, for Providing Improved Visibility, Quality Control and Audit Capability for Underground Facility Locate and/or Marking Operations;”

U.S. publication no. 2010-0324967-A1, published Dec. 23, 2010, filed Jul. 9, 2010, and entitled “Management System, and Associated Methods and Apparatus, for Dispatching Tickets, Receiving Field Information, and Performing A Quality Assessment for Underground Facility Locate and/or Marking Operations;”

U.S. publication no. 2010-0318401-A1, published Dec. 16, 2010, filed Jul. 9, 2010, and entitled “Methods and Apparatus for Performing Locate and/or Marking Operations with Improved Visibility, Quality Control and Audit Capability;”

U.S. publication no. 2010-0318402-A1, published Dec. 16, 2010, filed Jul. 9, 2010, and entitled “Methods and Apparatus for Managing Locate and/or Marking Operations;”

U.S. publication no. 2010-0318465-A1, published Dec. 16, 2010, filed Jul. 9, 2010, and entitled “Systems and Methods for Managing Access to Information Relating to Locate and/or Marking Operations;”

U.S. publication no. 2010-0201690-A1, published Aug. 12, 2010, filed Apr. 13, 2009, and entitled “Virtual White Lines (VWL) Application for Indicating a Planned Excavation or Locate Path;”

U.S. publication no. 2010-0205554-A1, published Aug. 12, 2010, filed Apr. 13, 2009, and entitled “Virtual White Lines (VWL) Application for Indicating an Area of Planned Excavation;”

U.S. publication no. 2009-0202112-A1, published Aug. 13, 2009, filed Feb. 11, 2009, and entitled “Searchable Electronic Records of Underground Facility Locate Marking Operations;”

U.S. publication no. 2009-0204614-A1, published Aug. 13, 2009, filed Feb. 11, 2009, and entitled “Searchable Electronic Records of Underground Facility Locate Marking Operations;”

U.S. publication no. 2011-0060496-A1, published Mar. 10, 2011, filed Aug. 10, 2010, and entitled “Systems and Methods for Complex Event Processing of Vehicle Information and Image Information Relating to a Vehicle;”

U.S. publication no. 2011-0093162-A1, published Apr. 21, 2011, filed Dec. 28, 2010, and entitled “Systems And Methods For Complex Event Processing Of Vehicle-Related Information;”

U.S. publication no. 2011-0093306-A1, published Apr. 21, 2011, filed Dec. 28, 2010, and entitled “Fleet Management Systems And Methods For Complex Event Processing Of Vehicle-Related Information Via Local And Remote Complex Event Processing Engines;”

U.S. publication no. 2011-0093304-A1, published Apr. 21, 2011, filed Dec. 29, 2010, and entitled “Systems And Methods For Complex Event Processing Based On A Hierarchical Arrangement Of Complex Event Processing Engines;”

U.S. publication no. 2010-0257477-A1, published Oct. 7, 2010, filed Apr. 2, 2010, and entitled “Methods, Apparatus, and Systems for Documenting and Reporting Events Via Time-Elapsed Geo-Referenced Electronic Drawings;”

U.S. publication no. 2010-0256981-A1, published Oct. 7, 2010, filed Apr. 2, 2010, and entitled “Methods, Apparatus, and Systems for Documenting and Reporting Events Via Time-Elapsed Geo-Referenced Electronic Drawings;”

U.S. publication no. 2010-0205032-A1, published Aug. 12, 2010, filed Feb. 11, 2010, and entitled “Marking Apparatus Equipped with Ticket Processing Software for Facilitating Marking Operations, and Associated Methods;”

U.S. publication no. 2011-0035251-A1, published Feb. 10, 2011, filed Jul. 15, 2010, and entitled “Methods, Apparatus, and Systems for Facilitating and/or Verifying Locate and/or Marking Operations;”

U.S. publication no. 2011-0035328-A1, published Feb. 10, 2011, filed Jul. 15, 2010, and entitled “Methods, Apparatus, and Systems for Generating Technician Checklists for Locate and/or Marking Operations;”

U.S. publication no. 2011-0035252-A1, published Feb. 10, 2011, filed Jul. 15, 2010, and entitled “Methods, Apparatus, and Systems for Processing Technician Checklists for Locate and/or Marking Operations;”

U.S. publication no. 2011-0035324-A1, published Feb. 10, 2011, filed Jul. 15, 2010, and entitled “Methods, Apparatus, and Systems for Generating Technician Workflows for Locate and/or Marking Operations;”

U.S. publication no. 2011-0035245-A1, published Feb. 10, 2011, filed Jul. 15, 2010, and entitled “Methods, Apparatus, and Systems for Processing Technician Workflows for Locate and/or Marking Operations;”

U.S. publication no. 2011-0035260-A1, published Feb. 10, 2011, filed Jul. 15, 2010, and entitled “Methods, Apparatus, and Systems for Quality Assessment of Locate and/or Marking Operations Based on Process Guides;”

U.S. publication no. 2010-0256863-A1, published Oct. 7, 2010, filed Apr. 2, 2010, and entitled “Methods, Apparatus, and Systems for Acquiring and Analyzing Vehicle Data and Generating an Electronic Representation of Vehicle Operations;”

U.S. publication no. 2011-0022433-A1, published Jan. 27, 2011, filed Jun. 24, 2010, and entitled “Methods and Apparatus for Assessing Locate Request Tickets;”

U.S. publication no. 2011-0040589-A1, published Feb. 17, 2011, filed Jul. 21, 2010, and entitled “Methods and Apparatus for Assessing Complexity of Locate Request Tickets;”

U.S. publication no. 2011-0046993-A1, published Feb. 24, 2011, filed Jul. 21, 2010, and entitled “Methods and Apparatus for Assessing Risks Associated with Locate Request Tickets;”

U.S. publication no. 2011-0046994-A1, published Feb. 17, 2011, filed Jul. 21, 2010, and entitled “Methods and Apparatus for Multi-Stage Assessment of Locate Request Tickets;”

U.S. publication no. 2011-0040590-A1, published Feb. 17, 2011, filed Jul. 21, 2010, and entitled “Methods and Apparatus for Improving a Ticket Assessment System;”

U.S. publication no. 2011-0020776-A1, published Jan. 27, 2011, filed Jun. 25, 2010, and entitled “Locating Equipment for and Methods of Simulating Locate Operations for Training and/or Skills Evaluation;”

U.S. publication no. 2010-0285211-A1, published Nov. 11, 2010, filed Apr. 21, 2010, and entitled “Method Of Using Coded Marking Patterns In Underground Facilities Locate Operations;”

U.S. publication no. 2011-0137769-A1, published Jun. 9, 2011, filed Nov. 5, 2010, and entitled “Method Of Using Coded Marking Patterns In Underground Facilities Locate Operations;”

U.S. publication no. 2009-0327024-A1, published Dec. 31, 2009, filed Jun. 26, 2009, and entitled “Methods and Apparatus for Quality Assessment of a Field Service Operation;”

U.S. publication no. 2010-0010862-A1, published Jan. 14, 2010, filed Aug. 7, 2009, and entitled, “Methods and Apparatus for Quality Assessment of a Field Service Operation Based on Geographic Information;”

U.S. publication No. 2010-0010863-A1, published Jan. 14, 2010, filed Aug. 7, 2009, and entitled, “Methods and Apparatus for Quality Assessment of a Field Service Operation Based on Multiple Scoring Categories;”

U.S. publication no. 2010-0010882-A1, published Jan. 14, 2010, filed Aug. 7, 2009, and entitled, “Methods and Apparatus for Quality Assessment of a Field Service Operation Based on Dynamic Assessment Parameters;”

U.S. publication no. 2010-0010883-A1, published Jan. 14, 2010, filed Aug. 7, 2009, and entitled, “Methods and Apparatus for Quality Assessment of a Field Service Operation Based on Multiple Quality Assessment Criteria;”

U.S. publication no. 2011-0007076-A1, published Jan. 13, 2011, filed Jul. 7, 2010, and entitled, “Methods, Apparatus and Systems for Generating Searchable Electronic Records of Underground Facility Locate and/or Marking Operations;”

U.S. publication no. 2011-0131081-A1, published Jun. 2, 2011, filed Oct. 29, 2010, and entitled “Methods, Apparatus, and Systems for Providing an Enhanced Positive Response in Underground Facility Locate and Marking Operations;”

U.S. publication no. 2011-0060549-A1, published Mar. 10, 2011, filed Aug. 13, 2010, and entitled, “Methods and Apparatus for Assessing Marking Operations Based on Acceleration Information;”

U.S. publication no. 2011-0117272-A1, published May 19, 2011, filed Aug. 19, 2010, and entitled, “Marking Device with Transmitter for Triangulating Location During Locate Operations;”

U.S. publication no. 2011-0045175-A1, published Feb. 24, 2011, filed May 25, 2010, and entitled, “Methods and Marking Devices with Mechanisms for Indicating and/or Detecting Marking Material Color;”

U.S. publication no. 2011-0191058-A1, published Aug. 4, 2011, filed Aug. 11, 2010, and entitled, “Locating Equipment Communicatively Coupled to or Equipped with a Mobile/Portable Device;”

U.S. publication no. 2010-0088135 A1, published Apr. 8, 2010, filed Oct. 1, 2009, and entitled, “Methods and Apparatus for Analyzing Locate and Marking Operations with Respect to Environmental Landmarks;”

U.S. publication no. 2010-0085185 A1, published Apr. 8, 2010, filed Sep. 30, 2009, and entitled, “Methods and Apparatus for Generating Electronic Records of Locate Operations;”

U.S. publication no. 2011-0095885 A9 (Corrected Publication), published Apr. 28, 2011, and entitled, “Methods And Apparatus For Generating Electronic Records Of Locate Operations;”

U.S. publication no. 2010-0090700-A1, published Apr. 15, 2010, filed Oct. 30, 2009, and entitled “Methods and Apparatus for Displaying an Electronic Rendering of a Locate Operation Based on an Electronic Record of Locate Information;”

U.S. publication no. 2010-0085054 A1, published Apr. 8, 2010, filed Sep. 30, 2009, and entitled, “Systems and Methods for Generating Electronic Records of Locate And Marking Operations;” and

U.S. publication no. 2011-0046999-A1, published Feb. 24, 2011, filed Aug. 4, 2010, and entitled, “Methods and Apparatus for Analyzing Locate and Marking Operations by Comparing Locate Information and Marking Information.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1A is a perspective view of an example of an enhanced mobile dispensing device implemented as an enhanced spray wand, according to one embodiment of the present invention;

FIG. 1B is a perspective view of an example of an enhanced mobile dispensing device implemented as an enhanced spray gun, according to another embodiment of the present invention;

FIG. 2 is a functional block diagram of an example of the control electronics of the enhanced mobile dispensing devices, according to embodiments of the invention;

FIG. 3 is a functional block diagram of examples of input devices of the control electronics of the enhanced mobile dispensing devices, according to embodiments of the invention;

FIG. 4 is a perspective view of an enhanced mobile dispensing device that includes imaging equipment and software for performing optical flow-based dead reckoning and other processes, according to embodiments of the invention;

FIG. 5 is a functional block diagram of an example of the control electronics for supporting the optical flow-based dead reckoning and other processes of the enhanced mobile dispensing device of FIG. 4, according to embodiments of the invention;

FIG. 6 is an example of an optical flow plot that represents the path taken by the enhanced mobile dispensing device per the optical flow-based dead reckoning process, according to embodiments of the invention; and

FIG. 7 is a functional block diagram of an example of a dispensing operations system that includes a network of enhanced mobile dispensing devices, according to embodiments of the invention.

### DESCRIPTION

Following below are more detailed descriptions of various concepts related to, and embodiments of, inventive systems, methods and apparatus for dispensing materials and tracking same. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

Various embodiments of the present invention relate generally to enhanced mobile dispensing devices from which dispensed material may not be observable after use. The enhanced mobile dispensing devices of the present invention are geo-enabled electronic dispensing devices from which electronic information may be collected about the dispensing operations performed therewith. In this way, electronic records may be created about the dispensing operations in which the dispensed material may not be visible and/or otherwise observable. The enhanced mobile dispensing devices of the present invention may be implemented as any type of spray device, such as, but not limited to, an enhanced spray wand, an enhanced spray gun, an enhanced spray applicator, and the like for use with, for example, hand sprayers, backpack sprayers, truck-based bulk sprayers, and the like.

Example of industries in which liquid (or powder) material that is dispensed may not be observable may include, but are not limited to, dispensing liquid pesticides in home and/or office environments, dispensing liquid weed killers and/or fertilizers for lawn treatments, dispensing liquid weed killers and/or fertilizers in large-scale grower environments (e.g., large-scale grower of plants for sale and/or crops), and the like.

In one embodiment of the invention, the enhanced mobile dispensing devices may include systems, sensors, and/or devices that are useful for acquiring and/or generating electronic data that may be used for indicating and recording information about dispensing operations. For example, the systems, sensors, and/or devices may include, but are not limited to, one or more of the following types of devices: a temperature sensor, a humidity sensor, a light sensor, an electronic compass, an inclinometer, an accelerometer, an infrared (IR) sensor, a sonar range finder, an inertial measurement unit (IMU), an image capture device, and an audio recorder. Digital information that is acquired and/or generated by these systems, sensors, and/or devices may be used for generating electronic records about dispensing operations, as is discussed in detail in U.S. publication no. 2010-0189887 A1, published Jul. 29, 2010, filed Feb. 11, 2010, and entitled “Marking Apparatus Having Enhanced Features for Underground Facility Marking Operations, and Associated Methods and Systems,” which is incorporated herein by reference.

In another embodiment of the invention, the enhanced mobile dispensing devices may include image analysis software for processing image data from one or more digital video cameras. In one example, the image analysis software is used for performing an optical flow-based dead reckoning process and any other useful processes, such as, but not limited to, a surface type detection process.

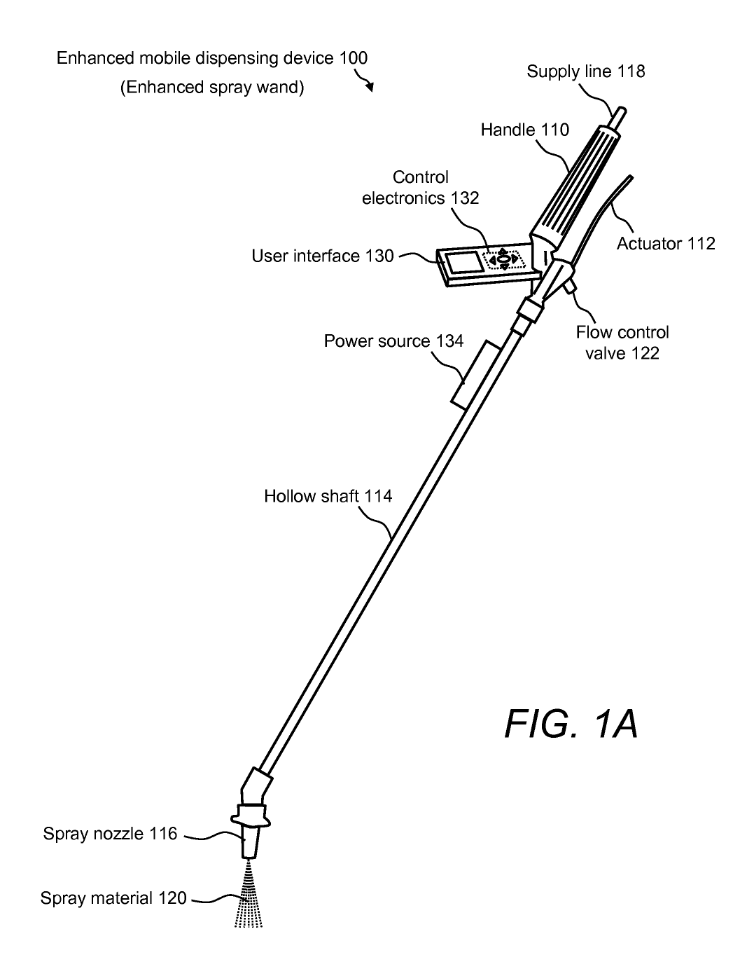

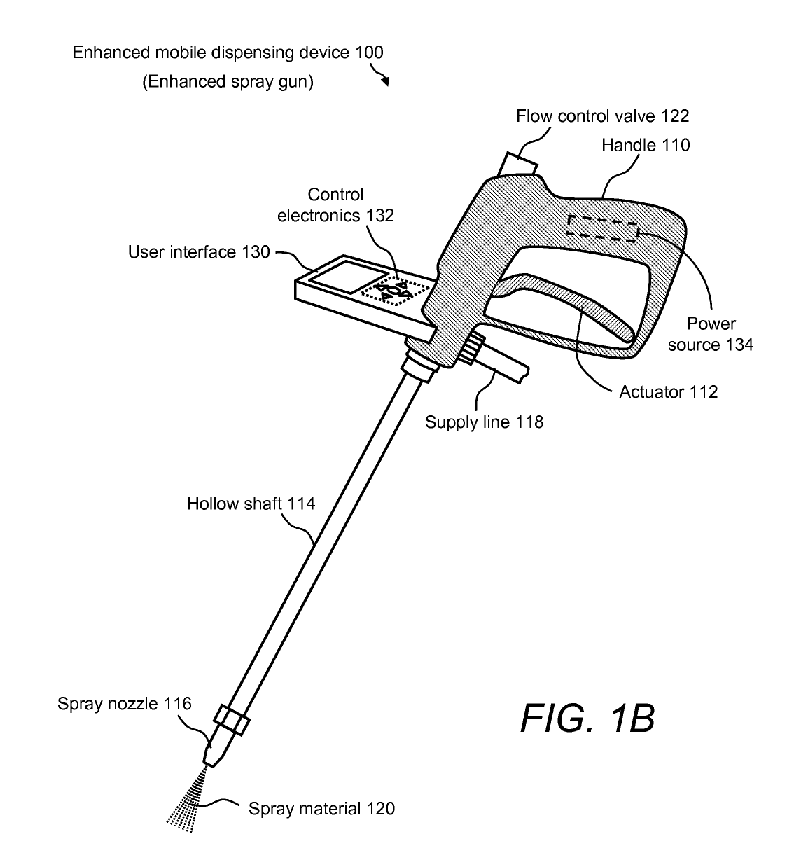

FIG. 1A is a perspective view of an example of an enhanced mobile dispensing device 100 implemented as an enhanced spray wand. FIG. 1B is a perspective view of an example of enhanced mobile dispensing device 100 implemented as an enhanced spray gun. Enhanced mobile dispensing devices 100 of FIGS. 1A and 1B are examples of enhanced mobile dispensing devices from which dispensed material may not be observable after use. Enhanced mobile dispensing devices 100 are geo-enabled electronic dispensing devices from which electronic information may be collected about the dispensing operations performed therewith. In this way, electronic records may be created about the dispensing operations in which the dispensed material may not be visible and/or otherwise observable.

Enhanced mobile dispensing device 100 of FIG. 1A and/or FIG. 1B includes a handle 110 and an actuator 112 arrangement that is coupled to one end of a hollow shaft 114. A spray nozzle 116 is coupled to the end of hollow shaft 114 that is opposite handle 110 and actuator 112. In the example of the enhanced spray wand of FIG. 1A, handle 110 is a wand type of handle and actuator 112 is arranged for convenient use while grasping handle 110. In the example of the enhanced spray gun of FIG. 1B, handle 110 is a pistol grip type of handle and actuator 112 is arranged in trigger fashion for convenient use while grasping handle 110.

A supply line 118 is coupled to handle 110. A source (not shown), such as a tank, of a liquid or powder material may feed supply line 118. A fluid path is formed by supply line 118, hollow shaft 114, and spray nozzle 116 for dispensing any type of spray material 120 from enhanced mobile dispensing device 100 by activating actuator 112. Other flow control mechanisms may be present in enhanced mobile dispensing device 100, such as, but not limited to, an adjustable flow control valve 122 for controlling the amount and/or rate of spray material 120 that is dispensed when actuator 112 is activated. Examples of spray material 120 that may not be observable (i.e., not visible) after application may include, but are not limited to, liquid (or powder) pesticides, liquid (or powder) weed killers, liquid (or powder) fertilizers, and the like.

Unlike prior art mobile dispensing devices, enhanced mobile dispensing device 100 is a geo-enabled electronic mobile dispensing device. That is, enhanced mobile dispensing device 100 includes an electronic user interface 130 and control electronics 132. User interface 130 may be any mechanism or combination of mechanisms by which the user may operate enhanced mobile dispensing device 100 and by which information that is generated and/or collected by enhanced mobile dispensing device 100 may be presented to the user. For example, user interface 130 may include, but is not limited to, a display, a touch screen, one or more manual pushbuttons, one or more light-emitting diode (LED) indicators, one or more toggle switches, a keypad, an audio output (e.g., speaker, buzzer, and alarm), and any combinations thereof.

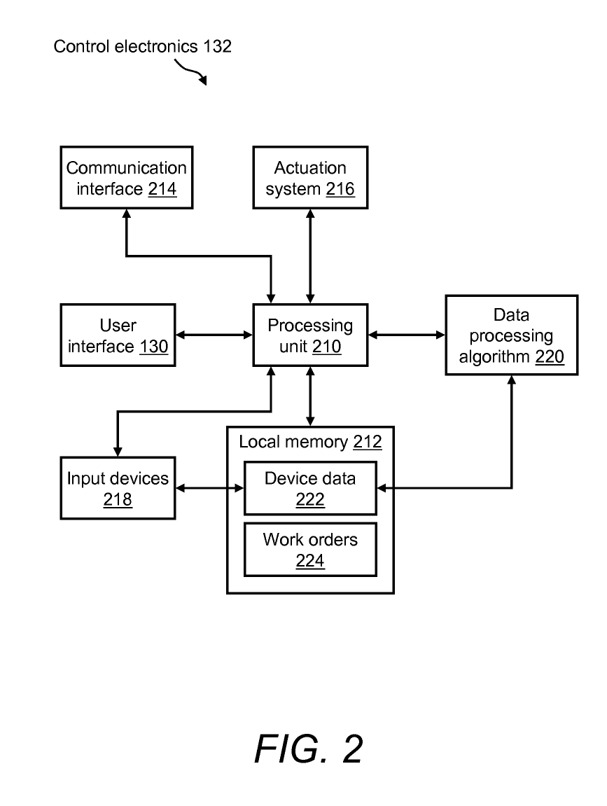

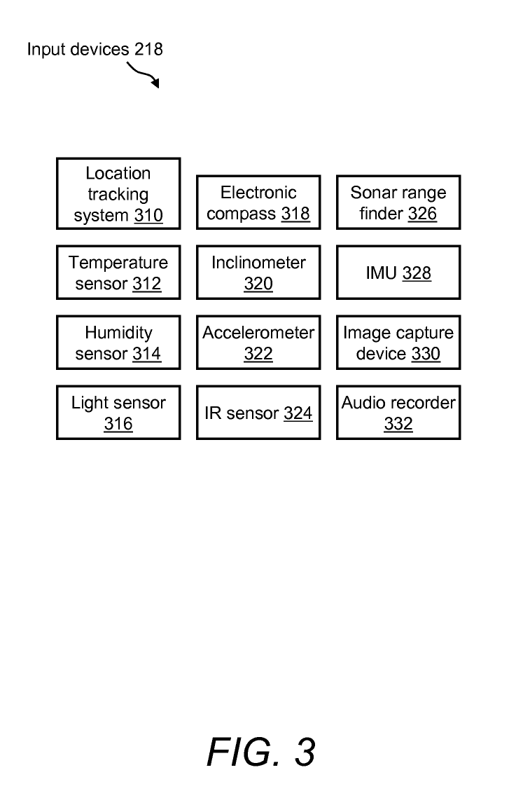

In one example, control electronics 132 is installed in the housing of user interface 130. In certain embodiments, the housing is adapted to be held in a hand of a user (i.e., the housing is configured as a hand-held housing). Control electronics 132 is used to control the overall operations of enhanced mobile dispensing device 100. In particular, control electronics 132 is used to manage electronic information that is generated and/or collected using systems, sensors, and/or devices that are useful for acquiring and/or generating data installed in enhanced mobile dispensing device 100. Additionally, control electronics 132 is used to process this electronic information to create electronic records of dispensing operations. The electronic records of dispensing operations are useful for verifying, recording, and/or otherwise indicating work that has been performed, wherein dispensed material may not be observable after completing the work. Details of control electronics 132 are described with reference to FIG. 2. Details of examples of systems, sensors, and/or devices that are useful for acquiring and/or generating data of enhanced mobile dispensing device 100 are described with reference to FIG. 3.

The components of enhanced mobile dispensing device 100 may be powered by a power source 134. Power source 134 may be any power source that is suitable for use in a portable device, such as, but not limited to, one or more rechargeable batteries, one or more non-rechargeable batteries, a solar electrovoltaic panel, a standard AC power plug feeding an AC-to-DC converter, and the like. In the example of the enhanced spray wand of FIG. 1A, power source 134 may be, for example, a battery pack installed along hollow shaft 114. In the example of the enhanced spray gun of FIG. 1B, power source 134 may be, for example, a battery pack installed in the body of handle 110.

FIG. 2 is a functional block diagram of an example of control electronics 132 of enhanced mobile dispensing device 100. In this example, control electronics 132 is in communication with user interface 130. Further, control electronics 132 may include, but is not limited to, a processing unit 210, a local memory 212, a communication interface 214, an actuation system 216, input devices 218, and a data processing algorithm 220 for managing the information returned from input devices 218.

Processing unit 210 may be any general-purpose processor, controller, or microcontroller device capable of managing the overall operations of enhanced mobile dispensing device 100, including managing data returned from any component thereof. Local memory 212 may be any volatile or non-volatile data storage device, such as, but not limited to, a random access memory (RAM) device and a removable memory device (e.g., a universal serial bus (USB) flash drive). An example of information that is stored in local memory 212 is device data 222. The contents of device data 222 may include digital information about dispensing operations. Additionally, work orders 224, which are provided in electronic form, may be stored in local memory 212. Work orders 224 may be instructions for conducting dispensing operations performed in the field.

Communication interface 214 may be any wired and/or wireless communication interface for connecting to a network (not shown) and by which information (e.g., the contents of local memory 212) may be exchanged with other devices connected to the network. Examples of wired communication interfaces may include, but are not limited to, USB protocols, RS232 protocol, RS422 protocol, IEEE 1394 protocol, Ethernet protocols, and any combinations thereof. Examples of wireless communication interfaces may include, but are not limited to, an Intranet connection; an Internet connection; radio frequency (RF) technology, such as, but not limited to, Bluetooth®, ZigBee®, Wi-Fi, Wi-Max, IEEE 802.11; and any cellular protocols; Infrared Data Association (IrDA) compatible protocols; optical protocols (i.e., relating to fiber optics); Local Area Networks (LAN); Wide Area Networks (WAN); Shared Wireless Access Protocol (SWAP); any combinations thereof and other types of wireless networking protocols.

Actuation system 216 may include a mechanical and/or electrical actuator mechanism (not shown) coupled to a flow valve that causes, for example, liquid to be dispensed from enhanced mobile dispensing device 100. Actuation means starting or causing enhanced mobile dispensing device 100 to work, operate, and/or function. Examples of actuation may include, but are not limited to, any local or remote, physical, audible, inaudible, visual, non-visual, electronic, electromechanical, biomechanical, biosensing or other signal, instruction, or event. Actuations of enhanced mobile dispensing device 100 may be performed for any purpose, such as, but not limited to, for dispensing spray material 120 and for capturing any information of any component of enhanced mobile dispensing device 100 without dispensing spray material 120. In one example, an actuation may occur by pulling or pressing a physical trigger (e.g., actuator 112) of enhanced mobile dispensing device 100 that causes spray material 120 to be dispensed.

Input devices 218 may be, for example, any systems, sensors, and/or devices that are useful for acquiring and/or generating electronic information that may be used for indicating and recording the dispensing operations of enhanced mobile dispensing device 100. For example, input devices 218 of enhanced mobile dispensing device 100 may include, but are not limited to, one or more of the following types of devices: a location tracking system, a temperature sensor, a humidity sensor, a light sensor, an electronic compass, an inclinometer, an accelerometer, an IR sensor, a sonar range finder, an IMU, an image capture device, and an audio recorder. Digital information that is acquired and/or generated by input devices 218 may be stored in device data 222 of local memory 212. Each acquisition of data from any input device 218 is stored with date/time information and geo-location information. Details of examples of input devices 218 are described with reference to FIG. 3.

Data processing algorithm 220 may be, for example, any algorithm that is capable of processing device data 222 from enhanced mobile dispensing device 100 and associating this data with a work order 224.

FIG. 3 is a functional block diagram of examples of input devices 218 of control electronics 132 of enhanced mobile dispensing device 100. Input devices 218 may include, but are not limited to, one or more of the following types of devices: a location tracking system 310, a temperature sensor 312, a humidity sensor 314, a light sensor 316, an electronic compass 318, an inclinometer 320, an accelerometer 322, an IR sensor 324, a sonar range finder 326, an IMU 328, an image capture device 330, and an audio recorder 332.

Location tracking system 310 may include any device that can determine its geographical location to a specified degree of accuracy. For example, location tracking system 310 may include a GPS receiver, such as a global navigation satellite system (GNSS) receiver. A GPS receiver may provide, for example, any standard format data stream, such as a National Marine Electronics Association (NMEA) data stream. Location tracking system 310 may also include an error correction component (not shown), which may be any mechanism for improving the accuracy of the geo-location data. Geo-location data from location tracking system 310 is an example of information that may be stored in device data 222. In another embodiment, location tracking system 310 may include any device or mechanism that may determine location by any other means, such as by performing triangulation (e.g., triangulation using cellular radiotelephone towers).

Temperature sensor 312, humidity sensor 314, and light sensor 316 are examples of environmental sensors for capturing the environmental conditions in which enhanced mobile dispensing device 100 is used. In one example, temperature sensor 312 may operate from about −40 C to about +125 C. In one example, humidity sensor 314 may provide the relative humidity measurement (e.g., 0% to 100% humidity). In one example, light sensor 316 may be a cadmium sulfide (CdS) photocell, which is a photoresistor device whose resistance decreases with increasing incident light intensity. In this example, the data that is returned from light sensor 316 is a resistance measurement. In dispensing applications, the ambient temperature, humidity, and light intensity in the environment in which enhanced mobile dispensing device 100 is operated may be captured via temperature sensor 312, humidity sensor 314, and light sensor 316, respectively, and stored in device data 222.

There may be a recommended ambient temperature range in which certain types of spray material 120 may be dispensed. Therefore, temperature sensor 312 may be utilized to detect the current air temperature. When the current temperature is outside the recommended operating range, control electronics 132 may generate an audible and/or visual alert to the user. Optionally, upon generation of the alert, actuation system 216 of enhanced mobile dispensing device 100 may be disabled.

There may be a recommended ambient humidity range in which certain types of spray material 120 may be dispensed. Therefore, humidity sensor 314 may be utilized to detect the current humidity level. When the current humidity level is outside the recommended operating range, control electronics 132 may generate an audible and/or visual alert to the user. Optionally, upon generation of the alert, actuation system 216 of enhanced mobile dispensing device 100 may be disabled.

Because enhanced mobile dispensing device 100 may be used in conditions of low lighting, such as late night, early morning, and heavy shade, artificial lighting may be required for safety and accurately performing the dispensing operation. Consequently, an illumination device (not shown), such as a flashlight or LED torch component, may be installed on enhanced mobile dispensing device 100. Light sensor 316 may be utilized to detect the level of ambient light and determine whether the illumination device should be activated. As detected by light sensor 316, the threshold for activating the illumination device may be any light level at which the operator may have difficulty seeing in order to perform normal activities associated with the dispensing operation. Information about the activation of the illumination device may be stored in device data 222.

Electronic compass 318 may be any electronic compass device for providing the directional heading of enhanced mobile dispensing device 100. The heading means the direction toward which the electronic compass is moving, such as north, south, east, west, and any combinations thereof. Heading data from electronic compass 318 is yet another example of information that may be stored in device data 222.

An inclinometer is an instrument for measuring angles of slope (or tilt) or inclination of an object with respect to gravity. In one example, inclinometer 320 may be a multi-axis digital device for sensing the inclination of enhanced mobile dispensing device 100. Inclinometer data from inclinometer 320 is yet another example of information that may be stored in device data 222. In particular, inclinometer 320 is used to detect the current angle of enhanced mobile dispensing device 100 in relation to both the horizontal and vertical planes. This information may be useful when using enhanced mobile dispensing device 100 for determining the angle at which material is sprayed. Because there are limitations to the angle at which enhanced mobile dispensing device 100 can be utilized effectively, readings from inclinometer 320 may be used for generating an audible and/or visual alert/notification to the user. For example, an alert/notification may be generated by control electronics 132 when enhanced mobile dispensing device 100 is being held at an inappropriate angle. Optionally, upon generation of the alert, actuation system 216 of enhanced mobile dispensing device 100 may be disabled.

An accelerometer is a device for measuring acceleration and gravity-induced reaction forces. A multi-axis accelerometer is able to detect magnitude and direction of the acceleration as a vector quantity. The acceleration specification may be in terms of g-force, which is a measurement of an object's acceleration. Accelerometer data from accelerometer 322 is yet another example of information that may be stored in device data 222. Accelerometer 322 may be any standard accelerometer device, such as a 3-axis accelerometer. In one example, accelerometer 322 may be utilized to determine the motion (e.g., rate of movement) of enhanced mobile dispensing device 100 as it is utilized. Where inclinometer 320 may detect the degree of inclination across the horizontal and vertical axes, accelerometer 322 may detect movement across a third axis (depth), which allows, for example, control electronics 132 to monitor the manner in which enhanced mobile dispensing device 100 is used. The information captured by accelerometer 322 may be utilized in order to detect improper dispensing practices. Optionally, when improper dispensing practices are detected via accelerometer 322, actuation system 216 of enhanced mobile dispensing device 100 may be disabled.

IR sensor 324 is an electronic device that measures infrared light radiating from objects in its field of view. IR sensor 324 may be used, for example, to measure the temperature of the surface being sprayed or traversed. Surface temperature data from IR sensor 324 is yet another example of information that may be stored in device data 222.

A sonar (or acoustic) range finder is an instrument for measuring distance from the observer to a target. In one example, sonar range finder 326 may be the Maxbotix LV-MaxSonar-EZ4 Sonar Range Finder MB1040 from Pololu Corporation (Las Vegas, Nev.), which is a compact sonar range finder that can detect objects from 0 to 6.45 m (21.2 ft) with a resolution of 2.5 cm (1″) for distances beyond 15 cm (6″). In one example, sonar range finder 326 may be mounted in about the same plane as spray nozzle 116 and used to measure the distance between spray nozzle 116 and the target surface. Distance data from sonar range finder 326 is yet another example of information that may be stored in device data 222.

An IMU is an electronic device that measures and reports an object's acceleration, orientation, and gravitational forces by use of one or more inertial sensors, such as one or more accelerometers, gyroscopes, and compasses. IMU 328 may be any commercially available IMU device for detecting the acceleration, orientation, and gravitational forces of any device in which it is installed. In one example, IMU 328 may be the IMU 6 Degrees of Freedom (6 DOF) device, which is available from SparkFun Electronics (Boulder, Colo.). This SparkFun IMU 6 DOF device has Bluetooth® capability and provides 3 axes of acceleration data, 3 axes of gyroscopic data, and 3 axes of magnetic data. IMU data from IMU 328 is yet another example of information that may be stored in device data 222.

Image capture device 330 may be any image capture device that is suitable for use in a portable device, such as, but not limited to, the types of digital cameras that may be installed in portable phones, other digital cameras, wide angle digital cameras, 360 degree digital cameras, infrared (IR) cameras, video cameras, and the like. Image capture device 330 may be used to capture any images of interest that may be related to the current dispensing operation. The image data from image capture device 330 may be stored in device data 222 in any standard or proprietary image file format (e.g., JPEG, TIFF, BMP, etc.).

Audio recorder 332 may be any digital and/or analog audio capture device that is suitable for use in a portable device. A microphone (not shown) is associated with audio recorder 332. In the case of a digital audio recorder, the digital audio files may be stored in device data 222 in any standard or proprietary audio file format (e.g., WAV, MP3, etc.). Audio recorder 332 may be used to record information of interest related to the dispensing operation.

In operation, for each actuation of enhanced mobile dispensing device 100, data processing algorithm 220 may be used to create a record of information about the dispensing operation. For example, at each actuation of actuation system 216 of enhanced mobile dispensing device 100, information from input devices 218, such as, but not limited to, geo-location data, temperature data, humidity data, light intensity data, inclinometer data, accelerometer data, heading data, surface temperature data, distance data, IMU data, digital image data, and/or digital audio data, is timestamped and logged in device data 222.

In an actuation-based data collection scenario, actuation system 216 may be the mechanism that prompts the logging of any data of interest from input devices 218 in device data 222 at local memory 212. In one example, each time actuator 112 of enhanced mobile dispensing device 100 is pressed or pulled, any available information associated with the actuation event is acquired and device data 222 is updated accordingly. In a non-actuation-based data collection scenario, any data of interest from input devices 218 may be logged in device data 222 at local memory 212 at certain programmed intervals, such as every 100 milliseconds, every 1 second, every 5 seconds, and so on.

Additionally, electronic information from other external sources may be fed into and processed by control electronics 132 of mobile dispensing device 100. For example, pressure measurements and material level measurements from the tank (not shown) that feeds supply line 118 may be received and processed by control electronics 132.

Tables 1 and 2 below show examples of two records of device data 222 (i.e., data from two instants in time) that may be generated by enhanced mobile dispensing device 100 of the present invention. While certain information shown in Tables 1 and 2 is automatically captured from input devices 218, other information may be provided manually by the user. For example, the user may use user interface 130 to enter a work order number, a service provider ID, an operator ID, and the type of material being dispensed. Additionally, the dispensing device ID may be hard-coded into processing unit 210.

TABLE 1
Example record of device data 222 of
enhanced mobile dispensing device 100

| Device | Data returned |
|---|---|
| Service provider ID | 0482735 |
| Dispensing Device ID | A263554 |
| Operator ID | 8936252 |
| Work Order # | 7628735 |
| Material Type | Brand XYZ Liquid Pesticide |
| Timestamp data of processing | 12-Jul-2010; 09:35:15.2 |
| unit 210 | |
| Actuation system 216 status | ON |
| Geo-location data of location | 35° 43′ 34.52″ N, 78° 49′ 46.48″ W |
| tracking system 310 | |
| Temperature data of | 73 degrees F. |
| temperature sensor 312 | |
| Humidity data of humidity | 32% |
| sensor 314 | |
| Light data of light sensor 316 | 4.3 volts |
| Heading data of electronic | 213 degrees |
| compass 318 | |
| Inclinometer data of | −40 |
| inclinometer 320 | |
| Accelerometer data of | 0.285 g |
| accelerometer 322 | |
| Surface temperature data | 79 degrees F. |
| of IR sensor 324 | |
| Distance data of sonar | 6.3 inches |
| range finder 326 | |
| IMU data of IMU 328 | Accelerometer = 0.285 g, |
| | Angular acceleration = +52 degrees/sec, |
| | Magnetic Field = −23 micro Teslas (uT) |
| Surface type | Grass |
| Material level in tank | ¾ full |
| Tank operating pressure | 27 psi |

TABLE 2
Example record of device data 222 of
enhanced mobile dispensing device 100

| Device | Data returned |
|---|---|
| Service provider ID | 0482735 |
| Dispensing Device ID | A263554 |
| Operator ID | 8936252 |
| Work Order # | 7628735 |
| Material Type | Brand XYZ Liquid Pesticide |
| Timestamp data of processing | 12-Jul-2010; 09:35:19.7 |
| unit 210 | |
| Actuation system 216 status | ON |
| Geo-location data of location | 35° 43′ 34.49″ N, 78° 49′ 46.53″ W |
| tracking system 310 | |
| Temperature data of | 73 degrees F. |
| temperature sensor 312 | |
| Humidity data of humidity | 31% |
| sensor 314 | |
| Light data of light sensor 316 | 4.3 volts |
| Heading data of electronic | 215 degrees |
| compass 318 | |
| Inclinometer data of | −37 |
| inclinometer 320 | |
| Accelerometer data of | 0.271 g |
| accelerometer 322 | |
| Surface temperature data | 79 degrees F. |
| of IR sensor 324 | |
| Distance data of sonar | 5.9 inches |
| range finder 326 | |
| IMU data of IMU 328 | Accelerometer = 0.271 g, |
| | Angular acceleration = +131 degrees/sec, |
| | Magnetic Field = −45 micro Teslas (uT) |
| Surface type | Grass |
| Material level in tank | ¾ full |
| Tank operating pressure | 31 psi |

The electronic records created by use of enhanced mobile dispensing device 100 include at least the date, time, and geographic location of dispensing operations. Referring again to Tables 1 and 2, other information about dispensing operations may be determined by analyzing multiple records of device data 222. For example, the total onsite-time with respect to a work order 224 may be determined, the total number of actuations with respect to a work order 224 may be determined, the total spray coverage area with respect to a work order 224 may be determined, and the like. Individual records of device data 222, such as shown in Tables 1 and 2, as well as any aggregation of multiple records of device data 222 of enhanced mobile dispensing device 100 for forming any useful conclusions about dispensing operations are examples of electronic records of dispensing operations for which there is no observable way of knowing whether service has been performed.

Additionally, timestamped and geo-stamped digital images that are captured using image capture device 330 may be stored and associated with certain records of device data 222. In one example, image capture device 330 may be used to capture landmark and/or non-dispensing event during dispensing operations. For example, in an insect extermination application, along with dispensing material from enhanced mobile dispensing device 100, the user may be performing other non-dispensing activities, such as installing a termite spike at certain locations. In this example, image capture device 330 may be used to capture a timestamped and geo-stamped digital image of the termite spike when installed. In this way, an electronic record of this activity is stored along with the information in, for example, Tables 1 and 2. In this example, image capture device 330 may be triggered manually by the user via controls of user interface 130. Further, calibration and/or device health information may be stored along with the information in, for example, Tables 1 and 2.

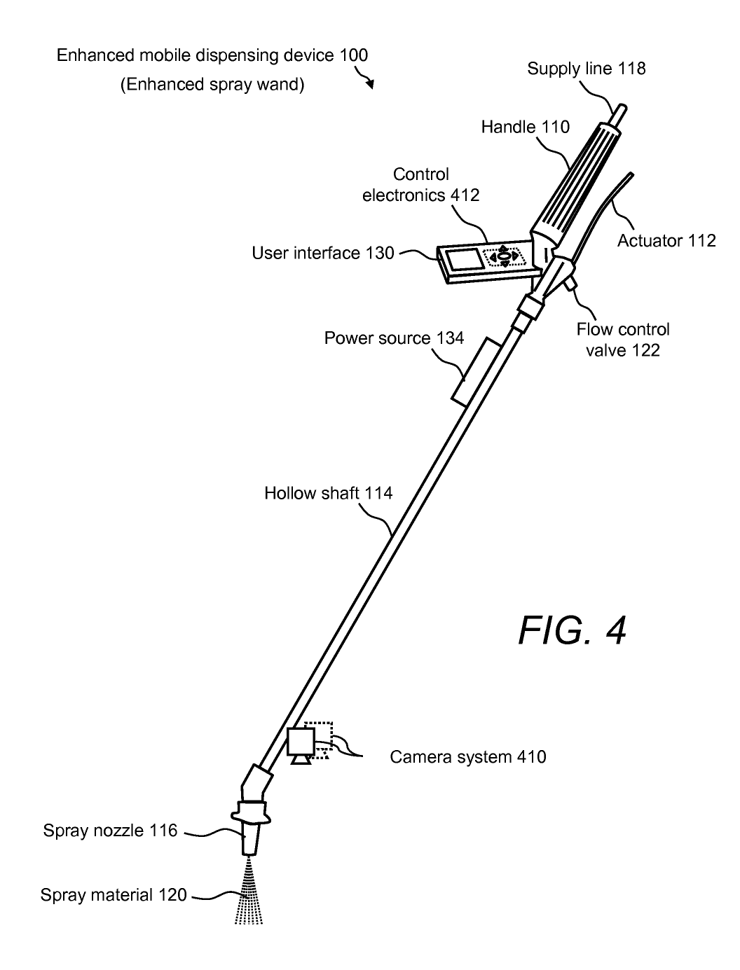

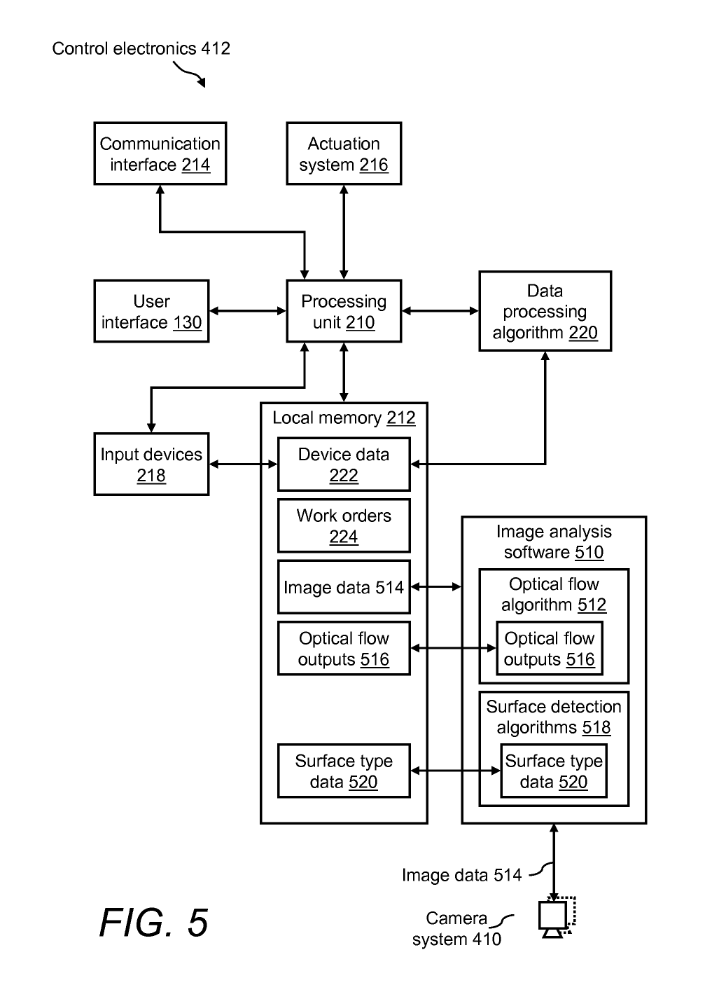

Referring to FIG. 4, a perspective view of an example of enhanced mobile dispensing device 100 that includes imaging equipment and software for performing optical flow-based dead reckoning and other processes is presented. In this example, enhanced mobile dispensing device 100 (e.g., an enhanced dispensing wand) includes a camera system. 410 and control electronics 412 that includes certain image analysis software for supporting the optical flow-based dead reckoning and other processes. More details of control electronics 412 supporting the optical flow-based dead reckoning and other processes are described with reference to FIG. 5.

The camera system 410 may include any standard digital video cameras that have a frame rate and resolution that is suitable, preferably optimal, for use in enhanced mobile dispensing device 100. Each digital video camera may be a universal serial bus (USB) digital video camera. In one example, each digital video camera may be the Sony PlayStation®Eye video camera that has a 10-inch focal length and is capable of capturing 60 frames/second, where each frame is, for example, 640×480 pixels. In this example, the optimal placement of at least one digital video camera on enhanced mobile dispensing device 100 is near spray nozzle 116 and is about 10 to 13 inches from the surface to be sprayed, when in use. This mounting position is important for two reasons: (1) so that the motion of at least one digital video camera tracks with the motion of the tip of enhanced mobile dispensing device 100 when dispensing spray material 120, and (2) so that some portion of the surface being sprayed is in the field of view (FOV) of at least one digital video camera.

In an alternative embodiment, the camera system may include one or more optical flow chips. The optical flow chip may include an image acquisition device and may measure changes in position of the chip (i.e., as mounted on the marking device) by optically acquiring sequential images and mathematically determining the direction and magnitude of movement. Exemplary optical flow chips may acquire images at up to 6400 times per second at a maximum of 1600 counts per inch (cpi), at speeds up to 40 inches per second (ips) and acceleration up to 15 g. The optical flow chip may operate in one of two modes: 1) gray tone mode, in which the images are acquired as gray tone images, and 2) color mode, in which the images are acquired as color images. In some embodiments, the optical flow chip may be used to provide information relating to whether the marking device is in motion or not.

In an exemplary implementation based on a camera system including an optical flow chip, the one or more optical flow chips may be selected as the ADNS-3080 chip available from Avago Technologies (e.g., see http://www.avagotech.com/pages/en/navigation_interface_devices/navigation_sensors/led-based_sensors/adns-3080/).

In one example, the digital output of the camera system 410 may be stored in any standard or proprietary video file format (e.g., Audio Video Interleave (.AVI) format and QuickTime (.QT) format). In another example, only certain frames of the digital output of the camera system 410 may be stored.

Referring to FIG. 5, a functional block diagram of an example of control electronics 412 for supporting the optical flow-based dead reckoning and other processes of enhanced mobile dispensing device 100 of FIG. 4 is presented. Dead reckoning is the process of estimating an object's current position based upon a previously determined position, and advancing that position based upon known or estimated speeds over elapsed time, and based upon direction. The optical flow-based dead reckoning that is incorporated in enhanced mobile dispensing device 100 of the present disclosure is useful for determining and recording the apparent motion of the device during dispensing operations and, thereby, track and log the movement that occurs during dispensing operations. For example, upon arrival at the job site, a user may activate the camera system 410 and the optical flow-based dead reckoning process of enhanced mobile dispensing device 100. A starting position, such as GPS latitude and longitude coordinates, is captured at the beginning of the dispensing operation. The optical flow-based dead reckoning process is performed throughout the duration of the dispensing operation with respect to the starting position. Upon completion of the dispensing operation, the output of the optical flow-based dead reckoning process, which indicates the apparent motion of the device throughout the dispensing operation, is saved in the electronic records of the dispensing operation.

Control electronics 412 is substantially the same as control electronics 132 of FIGS. 1A, 1B, 2, and 3, except that it further includes certain image analysis software 510 for supporting the optical flow-based dead reckoning and other processes of enhanced mobile dispensing device 100. Image analysis software 510 may be any image analysis software for processing the digital video output from the camera system 410. Image analysis software 510 may include, for example, an optical flow algorithm 512, which is the algorithm for performing the optical flow-based dead reckoning process of enhanced mobile dispensing device 100.

FIG. 5 also shows a camera system 410 connected to control electronics 412 of enhanced mobile dispensing device 100. In particular, image data 514 (e.g., .AVI and .QT file format, individual frames) of at least one digital video camera is passed to processing unit 210 and processed by image analysis software 510. Further, image data 514 may be stored in local memory 212.

Optical flow algorithm 512 of image analysis software 510 is used for performing an optical flow calculation for determining the pattern of apparent motion of a camera system 410, thereby, determining the pattern of apparent motion of enhanced mobile dispensing device 100. In one example, optical flow algorithm 512 may use the Pyramidal Lucas-Kanade method for performing the optical flow calculation. An optical flow calculation is the process of indentifying unique features (or groups of features) in common to at least two frames of image data (e.g., frames of image data 514) and, therefore, can be tracked from frame to frame. Then optical flow algorithm 512 compares the xy position (in pixels) of the common features in the at least two frames and determines the change (or offset) in xy position from one frame to the next as well as the direction of movement. Then optical flow algorithm 512 generates a velocity vector for each common feature, which represents the movement of the feature from one frame to the next frame. The results of the optical flow calculation of optical flow algorithm 512 may be saved in optical flow outputs 516.

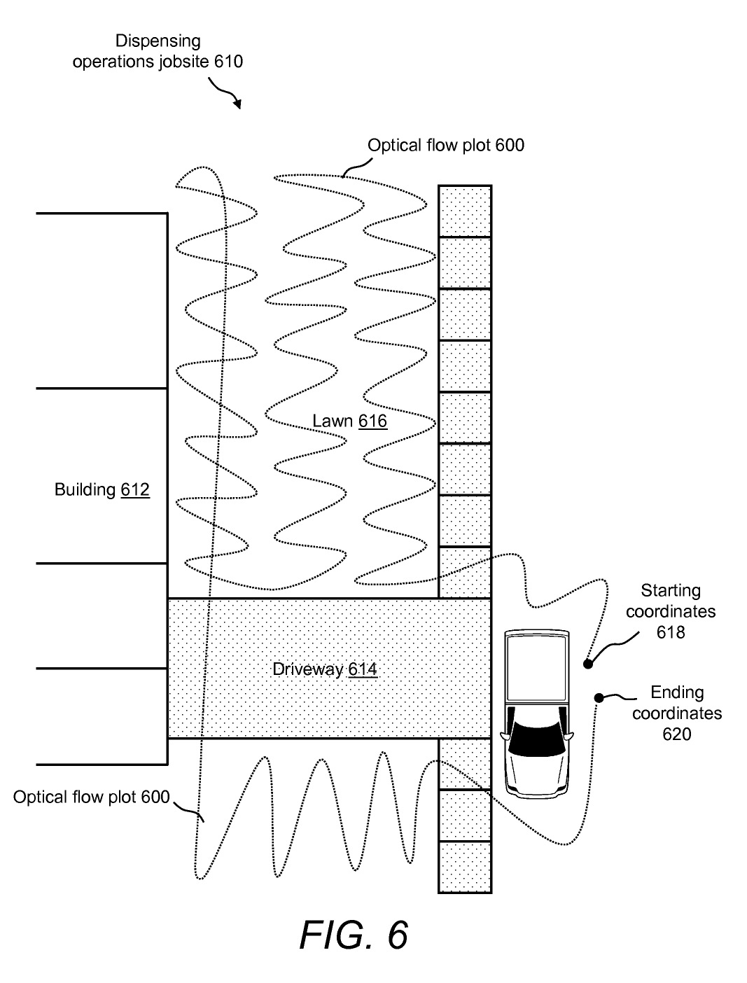

Optical flow outputs 516 may include the raw data processed by optical flow algorithm 512 and/or graphical representations of the raw data. Optical flow outputs 516 may be stored in local memory 212. Additionally, in order to provide other information that may be useful in combination with the optical flow-based dead reckoning process, the information in optical flow outputs 516 may be tagged with actuation-based timestamps from actuation system 216. These actuation-based timestamps are useful to indicate when spray material 120 is dispensed during dispensing operations with respect to the optical flow. For example, the information in optical flow outputs 516 may be tagged with timestamps for each actuation-on event and each actuation-off event of actuation system 216. More details of an example optical flow output 516 of optical flow algorithm 512 are described with reference to FIG. 6.

Certain input devices 218 may be used in combination with optical flow algorithm 512 for providing information that may improve the accuracy of the optical flow calculation. In one example, a range finding device, such sonar range finder 326, may be used for determining the distance between the camera system 410 and the target surface. Preferably, sonar range finder 326 is mounted in about the same plane as the FOV of the one or more digital video cameras. Therefore, sonar range finder 326 may measure the distance between the one or more digital video cameras and the target surface. The distance measurement from sonar range finder 326 may support a distance input parameter of optical flow algorithm 512, which is useful for accurately processing image data 514.

In another example, in place of or in combination with sonar range finder 326, two digital video cameras may be used to perform a range finding function, which is to determine the distance between a certain digital video camera and the target surface to be sprayed. More specifically, two digital video cameras may be used to perform a stereoscopic (or stereo vision) range finder function, which is well known. For range finding, the two digital video cameras are preferably a certain optimal distance apart and the two FOVs have an optimal percent overlap (e.g., 50%-66% overlap). In this scenario, the two digital video cameras may or may not be mounted in the same plane.

In yet another example, IMU 328 may be used for determining the orientation and/or angle of digital video cameras with respect to the target surface. An angle measurement from IMU 328 may support an angle input parameter of optical flow algorithm 512, which is useful for accurately processing image data 514.

Further, when performing the optical flow-based dead reckoning process, geo-location data from location tracking system 310 may be used for capturing the starting position of enhanced mobile dispensing device 100.

Referring to FIG. 6, an example of an optical flow plot 600 that represents the path taken by enhanced mobile dispensing device 100 per the optical flow-based dead reckoning process is presented. In order to provide context, optical flow plot 600 is overlaid atop, for example, a top down view of a dispensing operations jobsite 610. Depicted in dispensing operations jobsite 610 is a building 612, a driveway 614, and a lawn 616. Optical flow plot 600 is overlaid atop driveway 614 and lawn 616. Optical flow plot 600 has starting coordinates 618 and ending coordinates 620.

Optical flow plot 600 indicates the continuous path taken by enhanced mobile dispensing device 100 between starting coordinates 618, which may be the beginning of the dispensing operation, and ending coordinates 620, which may be the end of the dispensing operation. Starting coordinates 618 may indicate the position of enhanced mobile dispensing device 100 when first activated upon arrival at dispensing operations jobsite 610. By contrast, ending coordinates 620 may indicate the position of enhanced mobile dispensing device 100 when deactivated upon departure from dispensing operations jobsite 610. The optical flow-based dead reckoning process of optical flow algorithm 512 is tracking the apparent motion of enhanced mobile dispensing device 100 along its path of use from starting coordinates 618 to ending coordinates 620. That is, an optical flow plot, such as optical flow plot 600, substantially mimics the path of motion of enhanced mobile dispensing device 100 when in use.

Optical flow algorithm 512 generates an optical flow plot, such as optical flow plot 600, by continuously determining the xy position offset of certain groups of pixels from one frame to the next of image data 514 of at least one digital video camera. Optical flow plot 600 is an example of a graphical representation of the raw data processed by optical flow algorithm 512. Along with the raw data itself, the graphical representation, such as optical flow plot 600, may be included in the contents of the optical flow output 516 for this dispensing operation. Additionally, raw data associated with optical flow plot 600 may be tagged with timestamp information from actuation system 216, which indicates when material is being dispensed along, for example, optical flow plot 600 of FIG. 6.

An example of an optical flow-based dead reckoning process may be summarized as follows. In one example, the optical flow-based dead reckoning process may be stopped and started manually by the user. For example, the use may manually start the process upon arrival at the job site. Then manually end the process upon departure from the job site. In another example, the optical flow-based dead reckoning process may be stopped and started automatically. For example, the process begins whenever IMU 328 detects the starting motion of enhanced mobile dispensing device 100 and the process ends whenever IMU 328 detects the ending motion of enhanced mobile dispensing device 100.

At least one digital video camera is activated. An initial starting position is determined by optical flow algorithm 512 reading the current latitude and longitude coordinates from location tracking system 310 and/or by the user manually entering the current latitude and longitude coordinates using user interface 130. Then optical flow-based dead reckoning process of optical flow algorithm 512 begins. That is, certain frames of image data 514 are tagged in real time with “actuation-on” timestamps from actuation system 216 and certain other frames of image data 514 are tagged in real time with “actuation-off” timestamps. Next, by processing image data 514 frame by frame, optical flow algorithm 512 identifies one or more visually identifiable features (or groups of features) in at least two frames, preferably multiple frames, of image data 514.

The pixel position offset portion of the optical flow calculation is then performed for determining the pattern of apparent motion of the one or more visually identifiable features (or groups of features). In one example, the optical flow calculation that is performed by optical flow algorithm 512 uses the Pyramidal Lucas-Kanade method for performing the optical flow calculation. In the optical flow calculation, for each frame of image data 514, optical flow algorithm 512 determines and logs the xy position (in pixels) of the features of interest. Optical flow algorithm 512 then determines the change or offset in the xy positions of the features of interest from frame to frame. Using distance information (i.e., height of camera from target surface) from sonar range finder 326, optical flow algorithm 512 correlates the number of pixels offset to an actual distance measurement (e.g., 100 pixels=1 cm). Relative to the FOV of the source digital video camera, optical flow algorithm 512 then determines the direction of movement of the features of interest. Further, an angle measurement from IMU 328 may support a dynamic angle input parameter of optical flow algorithm 512, which is useful for accurately processing image data 514.

Next, using the pixel offsets and direction of movement of each feature of interest, optical flow algorithm 512 generates a velocity vector for each feature that is being tracked from one frame to the next frame. The velocity vector represents the movement of the feature from one frame to the next frame. Optical flow algorithm 512 then generates an average velocity vector, which is the average of the individual velocity vectors of all features of interest that have been identified.

Upon completion of the optical flow-based dead reckoning process and using the aforementioned optical flow calculations, optical flow algorithm 512 generates an optical flow output 516 of the current video clip. In one example, optical flow algorithm 512 generates a table of timestamped position offsets with respect to the initial starting position (e.g., initial is latitude and longitude coordinates). In another example, optical flow algorithm 512 generates an optical flow plot, such as optical flow plot 600 of FIG. 6.

Next, the optical flow output 516 of the current video clip is stored. In one example, the table of timestamped position offsets with respect to the initial starting position (e.g., initial latitude and longitude coordinates), an optical flow plot (e.g., optical flow plot 600 of FIG. 6), every nth frame (every 10^{th} or 20^{th} frame) of image data 514, and timestamped readings from any input devices 116 (e.g., timestamped readings from IMU 328, sonar range finder 326, and location tracking system 310) are stored in optical flow output 516 at local memory 132. Information about dispensing operations that is stored in optical flow outputs 516 may be included in electronic records of dispensing operations.

Because a certain amount of error may be accumulating in the optical flow-based dead reckoning process, the position of enhanced mobile dispensing device 100 may be recalibrated at any time during the dead reckoning process. That is, the dead reckoning process is not limited to capturing and/or entering an initial starting location only. At anytime, optical flow algorithm 512 may be updated with known latitude and longitude coordinates from any source.

Another process that may be performed using image analysis software 510 in combination with the camera system 410 is a process of surface type detection. Examples of types of surfaces may include, but are not limited to, asphalt, concrete, wood, grass, dirt (or soil), brick, gravel, stone, snow, and the like. Additionally, some types of surfaces may be painted or unpainted. More than one type of surface may be present at a jobsite.

Referring again to FIG. 5, image analysis software 510 may therefore include one or more surface detection algorithms 518 for determining the type of surface being sprayed and recording the surface type in surface type data 520 at local memory 212. Surface type data is another example of information that may be stored in the electronic records of dispensing operations performed using enhanced mobile dispensing devices 100.

Examples of surface detection algorithms 518 may include, but are not limited to, a pixel value analysis algorithm, a color analysis algorithm, a pixel entropy algorithm, an edge detection algorithm, a line detection algorithm, a boundary detection algorithm, a discrete cosine transform (DCT) analysis algorithm, a surface history algorithm, and a dynamic weighted probability algorithm. One reason why multiple algorithms are executed in the process of determining the type of surface being sprayed or traversed is that any given algorithm may be more or less effective for determining certain types of surfaces. Therefore, the collective output of multiple algorithms is useful for making a final determination of the type of surface being sprayed or traversed.

Because certain types of surfaces have distinctly unique colors, the color analysis algorithm (not shown) may be used to perform a color matching operation. For example, the color analysis algorithm may be used to analyze the RGB color data of certain frames of image data 514 from digital video cameras. The color analysis algorithm then determines the most prevalent color that is present. Next, the color analysis algorithm may correlate the most prevalent color that is found to a certain type of surface.

The pixel entropy algorithm (not shown) is a software algorithm for measuring the degree of randomness of the pixels in image data 514 from digital video camera. Randomness may mean, for example, the consistency or lack thereof of pixel order in the image data. The pixel entropy algorithm measures the degree of randomness of the pixels in image data 514 and returns an average pixel entropy value. The greater the randomness of the pixels, the higher the average pixel entropy value. The lower the randomness of the pixels, the lower the average pixel entropy value. Next, the pixel entropy algorithm may correlate the randomness of the pixels to a certain type of surface.

Edge detection is the process of identifying points in a digital image at which the image brightness changes sharply (i.e., process of detecting extreme pixel differences). The edge detection algorithm (not shown) is used to perform edge detection on certain frames of image data 514 from at least one digital video camera. In one example, the edge detection algorithm may use the Sobel operator, which is well known. The Sobel operator calculates the gradient of the image intensity at each point, giving the direction of the largest possible increase from light to dark and/or from one color to another and the rate of change in that direction. The result therefore shows how “abruptly” or “smoothly” the image changes at that point and, therefore, how likely it is that that part of the image represents an edge, as well as how that edge is likely to be oriented. The edge detection algorithm may then correlate any edges found to a certain type of surface.

Additionally, the output of the edge detection algorithm feeds into the line detection algorithm for further processing to determine the line characteristics of certain frames of image data 514 from at least one digital video camera. Like the edge detection algorithm, the line detection algorithm (not shown) may be based on edge detection processes that use, for example, the Sobel operator. In a brick surface, lines are present between bricks; in a sidewalk, lines are present between sections of concrete; and the like. Therefore, the combination of the edge detection algorithm and the line detection algorithm may be used for recognizing the presence of lines that are, for example, repetitive, straight, and have corners. The line detection algorithm may then correlate any lines found to a certain type of surface.

Boundary detection is the process of detecting the boundary between two or more surface types. The boundary detection algorithm (not shown) is used to perform boundary detection on certain frames of image data 514 from at least one digital video camera. In one example, the boundary detection algorithm analyzes the four corners of the frame. When the two or more corners (or subsections) indicate different types of surfaces, the frame of image data 514 may be classified as a “multi-surface” frame. Once classified as a “multi-surface” frame, it may be beneficial to run the edge detection algorithm and the line detection algorithm. The boundary detection algorithm may analyze the two or more subsections using any image analysis processes of the disclosure for determining the type of surface found in any of the two or more subsections.

The DCT analysis algorithm (not shown) is a software algorithm for performing standard JPEG compression operation. As is well known, in standard JPEG compression operations DCT is applied to blocks of pixels for removing redundant image data. Therefore, the DCT analysis algorithm is used to perform standard JPEG compression on frames of image data 514 from digital video camera. The output of the DCT analysis algorithm may be a percent compression value. Further, there may be unique percent compression values for images of certain types of surfaces. Therefore, percent compression values may be correlated to different types of surfaces.

The surface history algorithm (not shown) is a software algorithm for performing a comparison of the current surface type as determined by one or more or any combinations of the aforementioned algorithms to historical surface type information. In an example, the surface history algorithm may compare the surface type of the current frame of image data 514 to the surface type information of previous frames of image data 514. For example, if there is a question of the current surface type being brick vs. wood, historical information of previous frames of image data 514 may indicate that the surface type is brick and, therefore, it is most likely that the current surface type is brick, not wood.

Along with a percent probability of matching, the output of each algorithm of the disclosure for determining the type of surface being marked or traversed (e.g., the pixel value analysis algorithm, the color analysis algorithm, the pixel entropy algorithm, the edge detection algorithm, the line detection algorithm, the boundary detection algorithm, the DCT analysis algorithm, and the surface history algorithm) may include a weight factor. The weight factor may be, for example, an integer value from 0-10 or a floating point value from 0-1. Each weight factor from each algorithm may indicate the importance of the particular algorithm's percent probability of matching value with respect to determining a final percent probability of matching. The dynamic weighted probability algorithm (not shown) is used to set dynamically the weight factor of each algorithm's output. The weight factors are dynamic because certain algorithms may be more or less effective for determining certain types of surfaces.

It may be beneficial to execute the pixel value analysis algorithm, the color analysis algorithm, the pixel entropy algorithm, the edge detection algorithm, the line detection algorithm, the boundary detection algorithm, the DCT analysis algorithm, and the surface history algorithm in combination in order to confirm, validate, verify, and/or otherwise support the outputs of any one or more of the algorithms.

Referring again to FIGS. 4, 5, and 6, image analysis software 510 is not limited to performing the optical flow-based dead reckoning process and surface type detection process. Image analysis software 510 may be used to perform any other processes that may be useful in the electronic record of dispensing operations.

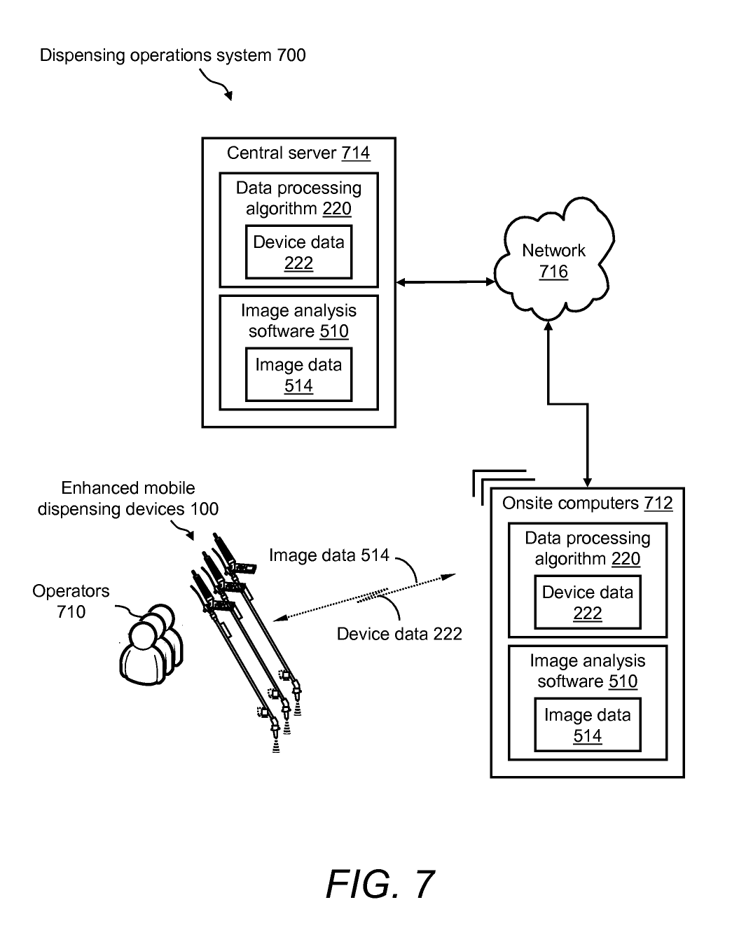

Referring to FIG. 7, a functional block diagram of an example of a dispensing operations system 700 that includes a network of enhanced mobile dispensing devices 100 is presented. More specifically, dispensing operations system 700 may include any number of enhanced mobile dispensing devices 100 that are operated by, for example, respective operators 710. Associated with each operator 710 and/or enhanced mobile dispensing device 100 may be an onsite computer 712. Therefore, dispensing operations system 700 may include any number of onsite computers 712.

Each onsite computer 712 may be any onsite computing device, such as, but not limited to, a computer that is present in the vehicle that is being used by operators 710 in the field. For example, onsite computer 712 may be a portable computer, a personal computer, a laptop computer, a tablet device, a personal digital assistant (PDA), a cellular radiotelephone, a mobile computing device, a touch-screen device, a touchpad device, or generally any device including, or connected to, a processor. Each enhanced mobile dispensing device 100 may communicate via its communication interface 214 with its respective onsite computer 712. More specifically, each enhanced mobile dispensing device 100 may transmit device data 222 to its respective onsite computer 712.

While an instance of data processing algorithm 220 and/or image analysis software 510 may reside and operate at each enhanced mobile dispensing device 100, an instance of data processing algorithm 220 and/or image analysis software 510 may also reside at each onsite computer 712. In this way, device data 222 and/or image data 514 may be processed at onsite computer 712 rather than at enhanced mobile dispensing device 100. Additionally, onsite computer 712 may be processing device data 222 and/or image data 514 concurrently to enhanced mobile dispensing device 100.

Additionally, dispensing operations system 700 may include a central server 714. Central server 714 may be a centralized computer, such as a central server of, for example, the spray dispensing service provider. A network 716 provides a communication network by which information may be exchanged between enhanced mobile dispensing devices 100, onsite computers 712, and central server 714. Network 716 may be, for example, any local area network (LAN) and/or wide area network (WAN) for connecting to the Internet. Enhanced mobile dispensing devices 100, onsite computers 712, and central server 714 may be connected to network 716 by any wired and/or wireless means.

While an instance of data processing algorithm 220 and/or image analysis software 510 may reside and operate at each enhanced mobile dispensing device 100 and/or at each onsite computer 712, an instance of data processing algorithm 220 and/or image analysis software 510 may also reside at central server 714. In this way, device data 222 and/or image data 514 may be processed at central server 714 rather than at each enhanced mobile dispensing device 100 and/or at each onsite computer 712. Additionally, central server 714 may be processing device data 222 and/or image data 514 concurrently to enhanced mobile dispensing device 100 and/or onsite computers 712.

Referring again to FIGS. 1A through 7, in other embodiments of enhanced mobile dispensing device 100, the built in control electronics, such as control electronics 132 of FIG. 2 and control electronics 412 of FIG. 5, may be replaced with a portable computing device that is electrically and/or mechanically coupled to enhanced mobile dispensing device 100. For example, the functions of control electronics 132 and/or control electronics 412 may be incorporated in, for example, a mobile telephone or a PDA device that is docked to enhanced mobile dispensing device 100. This embodiment provides an additional advantage of being able to move the portable computing device, which is detachable, from one enhanced mobile dispensing device 100 to another.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

Some embodiments may be implemented at least in part by a computer comprising a memory, one or more processing units (also referred to herein simply as “processors”), one or more communication interfaces, one or more display units, and one or more user input devices. The memory may comprise any computer-readable media, and may store computer instructions (also referred to herein as “processor-executable instructions”) for implementing the various functionalities described herein. The processing unit(s) may be used to execute the instructions. The communication interface(s) may be coupled to a wired or wireless network, bus, or other communication means and may therefore allow the computer to transmit communications to and/or receive communications from other devices. The display unit(s) may be provided, for example, to allow a user to view various information in connection with execution of the instructions. The user input device(s) may be provided, for example, to allow the user to make manual adjustments, make selections, enter data or various other information, and/or interact in any of a variety of manners with the processor during execution of the instructions.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A dispensing device for use in performing a dispensing operation to dispense a material, the dispensing device comprising:
a hand-held housing;
a memory to store processor-executable instructions;
at least one processor coupled to the memory and disposed within or communicatively coupled to the hand-held housing;
at least one camera system mechanically and/or communicatively coupled to the dispensing device so as to provide image information to the at least one processor, wherein the image information relates to the dispensing operation; and
a dispensing mechanism to control dispensing of the material, the material not being readily visible after the dispensing operation;
wherein the at least one processor, upon execution of the processor-executable instructions:
A) analyzes the image information to determine tracking information indicative of a motion or an orientation of the dispensing device;
B) determines actuation information relating at least in part to user operation of the dispensing mechanism; and
C) stores, in the memory, the actuation information and the tracking information so as to provide an electronic record of one or more geographic locations at which the material is dispensed by the dispensing device.

2. The device of claim 1, wherein the camera system comprises at least one digital video camera.

3. The device of claim 1, wherein the camera system comprises an optical flow chip.

4. The device of claim 1, wherein A) comprises:
A1) obtaining an optical flow plot indicative of a path traversed by the dispensing device.

5. The device of claim 4, wherein the dispensing mechanism comprises:
an actuator configured to:
dispense the material from a container; and
store, in the memory, information about the dispensing of the material.

6. The device of claim 5, wherein the processor is configured to:
in response to an actuation of the actuator, obtain timestamp information indicative of at least one period of time during which the actuator is actuated to dispense the material; and
uses the timestamp information and the optical flow plot obtained in A1) to identify portions of the path at which the dispensing device dispensed material.

7. The device of claim 1, wherein the processor:
D) obtains, using at least one device, supplemental tracking information indicative of at least one of a location, a motion, and an orientation of the dispensing device.
E) stores, in the memory, the supplemental tracking information.

8. The device of claim 7, wherein the at least one device comprises at least one of:
a global positioning system device, a triangulation device, an inertial measurement unit, an accelerometer, a gyroscope, a sonar range finder, a laser range finder, and an electronic compass.

9. The device of claim 1, wherein the material is at least one material selected from the group of liquid pesticide, powder pesticide, liquid weed killer, powder weed killer, and fertilizer.

10. The device of claim 1, further comprising at least one input device communicatively coupled to the at least one processor and configured to sense at least one environmental condition of an environment in which the dispensing device is located and provide an output signal to the at least one processor indicative of the sensed at least one environmental condition.

11. The device of claim 10, wherein the at least one input device comprises a temperature sensor and wherein the at least one environmental condition is a surface temperature of a surface on which material is to be dispensed.

12. The device of claim 10, wherein the at least one input device comprises a humidity sensor and wherein the at least one environmental condition is humidity of the environment.

13. The device of claim 10, wherein the at least one input device comprises a light sensor and wherein the at least one environmental condition is an amount of ambient light of the environment.

14. The device of claim 10, further comprising an image capture device configured to capture an image of the environment.

15. The device of claim 10, wherein the at least one input device comprises an audio recorder configured to record acoustic signals from the environment, and wherein the output signal represents at least part of a recording of the audio recorder.

16. The device of claim 10, wherein the at least one processor is programmed with processor-executable instructions which, when executed, cause the at least one processor to compare the output signal of the at least one input device to at least one target value.

17. The device of claim 16, wherein the at least one processor is further configured to disable dispensing of material in response to the comparison of the output signal of the at least one input device to the at least one target value.

18. The device of claim 1, further comprising at least one input device communicatively coupled to the at least one processor and configured to sense an operating condition of the dispensing device and provide an output signal to the at least one processor indicative of the sensed operating condition.

19. The device of claim 18, wherein the at least one input device communicatively coupled to the at least one processor and configured to sense an operating condition of the dispensing device is an accelerometer, and wherein the operating condition is an acceleration of the dispensing device.

20. The device of claim 19, wherein the accelerometer is a first accelerometer located at a first position of the dispensing device, and wherein the dispensing device further comprises a second accelerometer located at a second position of the dispensing device.

21. The device of claim 20, wherein each of the first and second accelerometers is a three-axis accelerometer.

22. The device of claim 18, wherein the at least one input device communicatively coupled to the at least one processor and configured to sense an operating condition of the dispensing device is an inclinometer and wherein the operating condition is an inclination of the dispensing device.

23. A computer program product comprising a non-transitory computer readable medium having a computer readable program code embodied therein, the computer readable program code adapted to be executed to implement a method comprising:
A) receiving image information from at least one camera system mechanically and/or communicatively coupled to a dispensing device adapted to dispense a material and having a dispensing mechanism to control dispensing of the material, the material not being readily visible after the dispensing operation;
B) analyzing the image information to determine tracking information indicative of a motion or an orientation of the dispensing device;
C) determining actuation information relating at least in part to user operation of the dispensing mechanism; and
D) storing, in a memory, the actuation information and the tracking information so as to provide an electronic record of one or more geographic locations at which the material is dispensed by the dispensing device.

24. A method of performing a dispensing operation to dispense a material, the method comprising:
A) receiving image information from at least one camera system mechanically and/or communicatively coupled to a dispensing device adapted to dispense a material and having a dispensing mechanism to control dispensing of the material, the material not being readily visible after the dispensing operation;
B) analyzing the image information to determine tracking information indicative of a motion or an orientation of the dispensing device;
C) determining actuation information relating at least in part to user operation of the dispensing mechanism; and
D) storing, in a memory, the actuation information and the tracking information so as to provide an electronic record of one or more geographic locations at which the material is dispensed by the dispensing device.
